(19) United States
(12) Patent Application Publication
(10) Pub. No.: US 2008/0159322 A1
(43) Pub. Date: Jul. 3, 2008

(54) NETWORK APPARATUS AND CONTROL METHOD THEREOF

(75) Inventor: Yoshinobu Takagi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/861,871

(22) Filed: Sep. 26, 2007

(30) Foreign Application Priority Data
Dec. 28, 2006 (JP) 2006-353896

(51) Int. Cl. H04L 12/56

(52) U.S. Cl. 370/419

(57) ABSTRACT

An L2/L3 switch comprises a plurality of ports for transferring data and exchanges data between the ports. Information of the ports exchanging data is registered in a database stored in memory. A communication system detects reception of a specified signal. A CPU comprised in a router controls the L2/L3 switch when the communication system detects the reception of the specified signal and causes data to be exchanged only between the ports indicated in the information registered in the database and stops data transfer of the other ports among the plurality of ports.

### BACKGROUND OF THE INVENTION

1. Field of the Invention

The present invention relates to a data exchange technology and specifically to a technology for ensuring that there is a communication network for a specific communication in a time of emergency.

2. Description of the Related Art

Public awareness of disaster control has been growing rapidly in recent years. Ensuring that there is a communication network in a time of disaster such as an earthquake or tsunami must be given top priority, and in Japan this priority is codified in laws such as the Telecommunications Business Law and the Radio Law.

Network apparatuses such as routers and switches for exchanging data transmitted in a communication network may be backed up by an auxiliary power source such as a UPS (Uninterruptible Power Supply) in order to prevent the apparatus from going down due to a blackout in a time of emergency such as a natural disaster.

However, many of the network apparatuses require a large amount of power (e.g. approximately 50-700 W), and it is therefore not easy to realize long-term stable operation of the network apparatus via the auxiliary power source.

In relation to the present invention, Japanese Patent Application Publication No. 2001-242967 discloses a technology such that when a certain signal is transmitted to other apparatuses via a network, the apparatus that received the signal stops functioning or resumes functioning if it has already stopped.

In a time of emergency such as a natural disaster, ensuring communications for weather information, communications for the police department and the fire department, and communications for broadcasting is crucial. However, it is not easy to realize long-term stable operation of network apparatuses under auxiliary power in order to ensure the viability of these communications (hereinafter each communication type is referred to as a “specially-designated communication”) in a time of emergency, as explained above. Additionally, in a communication network using a wire communication channel, the communication network may be disconnected because the communication channel may be physically cut when a disaster occurs.

### SUMMARY OF THE INVENTION

It is an object of the present invention to provide a communication network that ensures the viability of specially-designated communications even in a time of emergency.

A network apparatus that is one of the embodiments of the present invention comprises a data exchange unit comprising a plurality of ports transferring data for exchanging data between the ports, a database for registering information of a port exchanging data, a detection unit for detecting reception of a specified signal, and a control unit for controlling the data exchange unit when the detection unit detects the reception of the specified signal so that data exchange can be caused to occur only between those ports from among the plurality of ports indicated by the information registered in the database and for stopping the data transfer of other ports.

According to the above configuration, data exchange is performed only between ports shown in a database when a certain signal reports the occurrence of an emergency situation. Therefore, it is possible to ensure a specially-designated communication in a time of emergency by performing the specially-designated communication between the ports.

It should be noted that the network apparatus relating to the present invention described above assumes, as an example, that the data is an IP packet.

In addition, the network apparatus relating to the present invention described above assumes, as an example, that the data exchange unit is an L2/L3 switch.

In the network apparatus relating to the present invention described above, the detection unit can be configured so as to detect reception of a specified signal transmitted via a wireless communication channel.

According to the configuration, even if a wire communication channel is blocked due to a disaster or for another reason, a specified signal can be transmitted via a wireless communication channel and a specially-designated communication can be ensured.

It should be noted that at that time, the specified signal detected by the detection unit will be a signal with a specified frequency.

Additionally, in the network apparatus relating to the present invention described above, the control unit can be configured so as to block, when the detection unit detects reception of the specified signal, power from being consumed for data transfer in ports other than the port indicated in the information registered in the database.

According to the configuration, because the power consumption of the network apparatus is reduced, the operation time during which the network apparatus is operated with an auxiliary power source can be prolonged.

Note that the control unit can be configured so as to stop, when the detection unit detects reception of the specified signal, the operation of all of a plurality of power source systems comprised in the network apparatus except for the power source system supplying power consumed for data exchange between ports indicated in the information registered in the database.

According to the configuration, the power consumption of the network apparatus can be reduced by saving the amount of power loss that occurred in the power source system for which the operation is to be stopped, and the operating time under which the network apparatus is operated with the auxiliary power source therefore can be prolonged.

Note that the control unit can be configured so as to stop the operation of a power source system supplying power consumed by the control unit executing control operations after control of the data exchange conducted in response to the reception of the specified signal by the detection unit.

According to the configuration, the power consumption of the network apparatus can be further reduced by saving the amount of power loss that occurred in the power source system operating the control unit, and therefore the operation time under which the network apparatus is operated with the auxiliary power source can be further prolonged.

A control method of a network apparatus that is another embodiment of the present invention comprising a plurality of ports transferring data and data exchange equipment for data exchange between the ports, establishes a database in a storage unit comprised in the network apparatus by registering the information of a port exchanging data, determines whether or not a detection unit for detecting reception of a specified signal comprised in the network apparatus detected the reception of the specified signal, and causes the data exchange equipment, when detecting that the detection unit detects the reception of the specified signal, to exchange data only between ports indicated by information registered in the database and to stop data transfer between the other ports.

A control apparatus of a network apparatus that is another embodiment of the present invention comprising a plurality of ports transferring data and data exchange equipment for data exchange, comprises a database having the information of a port exchanging data registered, a detection unit for detecting reception of a specified signal, and a control unit for causing data to be exchanged only between ports indicated by the information registered in the database and for causing data transfer between the other ports to be stopped by controlling data exchange equipment comprised in the network apparatus when the detection unit detects reception of the specified signal.

### BRIEF DESCRIPTION OF THE DRAWINGS

The present invention will be more apparent from the following detailed description when the accompanying drawings are referenced.

FIG. 1 is a diagram showing an example of a communication network comprising the network apparatus implementing the present invention;

FIG. 2 is a diagram showing the configuration of the network apparatus in FIG. 1;

FIG. 3 is a diagram showing a first detailed example of a configuration of the router shown in FIG. 2;

FIG. 4 is a diagram showing the transmission of an emergency report signal:

FIG. 5 is a diagram showing an example of settings of the disaster database;

FIG. 6A is a diagram explaining the operation of the router in the normal operation mode;

FIG. 6B is a diagram explaining the operation of the router in the disaster operation mode;

FIG. 7 is a diagram showing an example of settings of the disaster database and MAC table in the router of each network apparatus constituting the communication network of FIG. 1;

FIG. 8 is a diagram showing the hardware resources required for maintenance of the communication channel for the specially-designated communication in the configuration of the router shown in detail in FIG. 3;

FIG. 9 is a diagram showing in a flowchart the contents of the control processing for the disaster operation mode; and

FIG. 10 is a diagram showing in detail a second example of the configuration of the router shown in FIG. 2.

### DESCRIPTION OF THE PREFERRED EMBODIMENT

In the following description, details of the embodiments of the present invention are set forth with reference to the drawings.

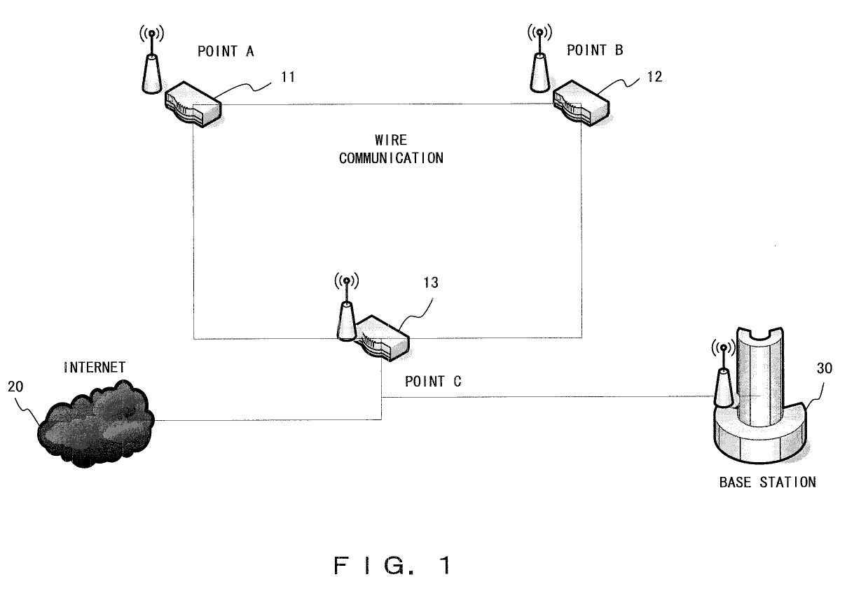

FIG. 1 is explained first. FIG. 1 shows an example of a communication network with a configuration using a network apparatus implementing the present invention. The communication network in this example is an IP network.

In FIG. 1, a network apparatus 11 placed at a point A, a network apparatus 12 placed at a point B, and a network apparatus 13 placed at a point C are all apparatuses for exchanging data (IP packets) transmitted in the communication network shown in FIG. 1.

Here, the network apparatus 11 is connected to both the network apparatus 12 and the network apparatus 13 via wire communication channels, and the network apparatus 12 is connected to the network apparatus 13 via a wire communication channel. In addition, the network apparatus 13 is connected to an Internet network 20 and a base station 30 by wire communication channels.

It should be noted that in the example of FIG. 1, the base station 30 is placed in a position directly connectable to each of the network apparatuses 11, 12 and 13 by wireless communication channels. And the network apparatus 13 is placed at a position directly connectable to each of the network apparatuses 11 and 12 by wireless communication channels. Meanwhile, the network apparatus 11 and the network apparatus 12 are placed in positions where direct connection cannot be made by the wireless communication channel.

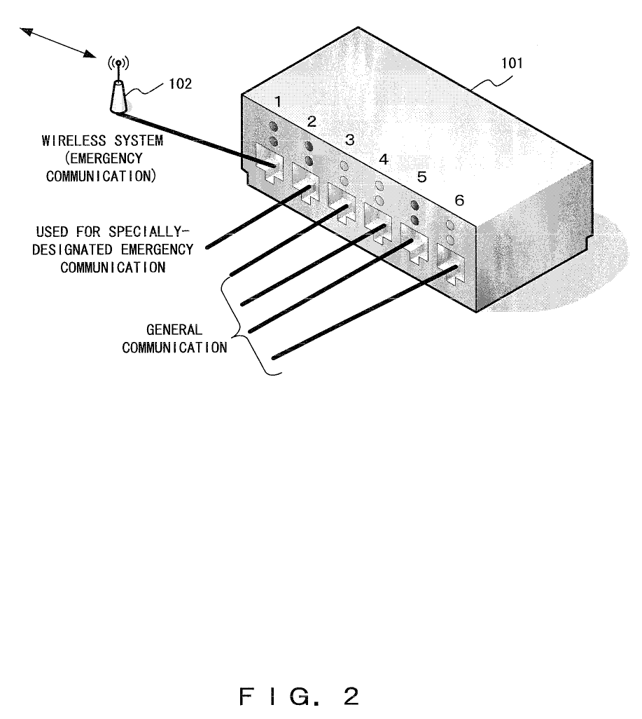

The configuration of the network apparatuses 11, 12 and 13 of FIG. 1 is shown in FIG. 2. As shown in FIG. 2, all of the network apparatuses 11, 12 and 13 comprise a router 101 and a wireless system 102.

The router 101 transfers data between ports and the wireless system 102 provides wireless communication channels to other network apparatuses. Here, one of the ports provided in the router 101 is connected to the wireless system 102, and another one of the ports is connected to another apparatus for the specially-designated communication explained above. The rest of the ports provided in the router 101 have wire communication channels connected for general communications other than the specially-designated communication.

It should be noted that the router 101 shown in FIG. 2 has six ports; however, the number of ports does not have to be six. Additionally, a switching hub can be used instead of a router.

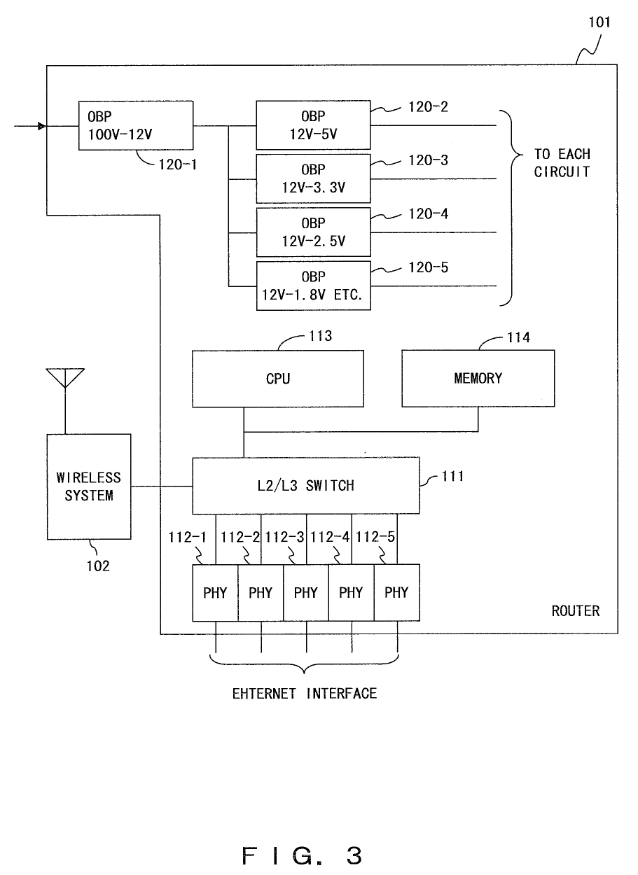

FIG. 3 shows a first detailed example of a configuration of the router 101 shown in FIG. 2.

In FIG. 3, an L2/L3 switch 111 is a circuit for transferring IP packets between ports according to header information. PHY 112-1 to PHY 112-5 are circuits for processing in a physical layer, and in the present embodiment, they are circuits for the processing of Ethernet flames exchanged with another apparatus for data communication. In the example of FIG. 1, one of the ports of the L2/L3 switch 111 is also connected to the wireless system 102 that comprises a wireless circuit for modulating/demodulating IP packets in response to a high-frequency signal and an aerial wire (antenna).

A CPU 113 is a central processing unit for controlling operation management of the entire router 101 by executing a prescribed control program. In addition, memory 114 has ROM and RAM. Here, the ROM stores the control program executed in the CPU 113 and a database explained later. The RAM is used as a temporary storage area for operation when the CPU 113 executes the control program.

On-board power supplies (OBPs) 120-1 to 120-5 convert the voltage of input power and supply the power to each unit of the router 101. In the example in FIG. 3, OBP 120-1 first converts a commercial power source (AC 100 volts) into 12 volts of DC voltage, and afterward the voltage is converted into the various voltages required for each unit, such as 5 volts, 3.3 volts, 2.5 volts, and 1.8 volts, by OBPs 120-2 to 120-5.

The router 101 is configured as described above. Note that in FIG. 3, it is possible to configure an apparatus comprising a wireless circuit system 102, a CPU 113, and memory 114 as a control apparatus for controlling the router 101 comprising an L2/L3 switch 111.

In the communication network shown in FIG. 1, the wireless communication channels between the network apparatuses 11 and 12, between the network apparatuses 12 and 13, and between the network apparatuses 13 and 11 are all connected to ports for general communications in the router 101 constituting each of the network apparatuses 11, 12 and 13. Additionally, for the router 101 constituting the network apparatus 13, the wire communication channel connecting it to the base station 30 and the wire communication channel connecting it to the Internet network 20 are connected to the port for general communications.

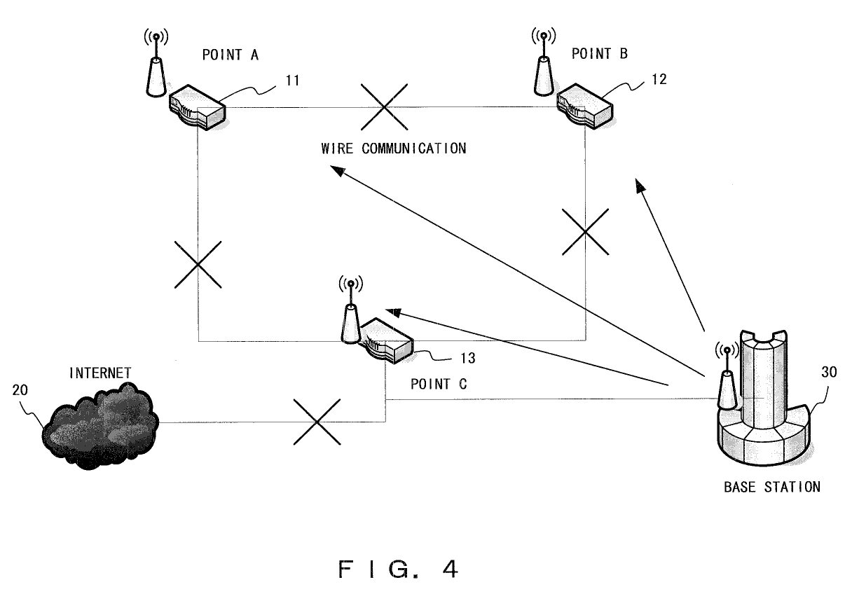

With such a network, when a disaster such as an earthquake or tsunami actually occurs, or if the occurrence of such a disaster is predicted, the base station 30 performs an emergency notice by transmitting a radio wave with a predetermined frequency modulated by a predetermined signal (emergency report signal). As shown in FIG. 4, the radio wave is received by the wireless system 102 that is comprised by each of the network apparatuses 11, 12 and 13. Accordingly, even if the wire communication channel in the communication network shown in FIG. 1 is disconnected (via disconnection of a communication cable or other such occurrence) due to the impact of a disaster or other such event, the emergency report signal reaches the wireless system 102 via the wireless communication channel.

The CPU 113 of the router 101 that is comprised by each of the network apparatuses 11, 12 and 13, when being notified by the wireless system 102 of the reception of the emergency report signal, shifts the operation status of the router 101 from normal operation mode to disaster operation mode.

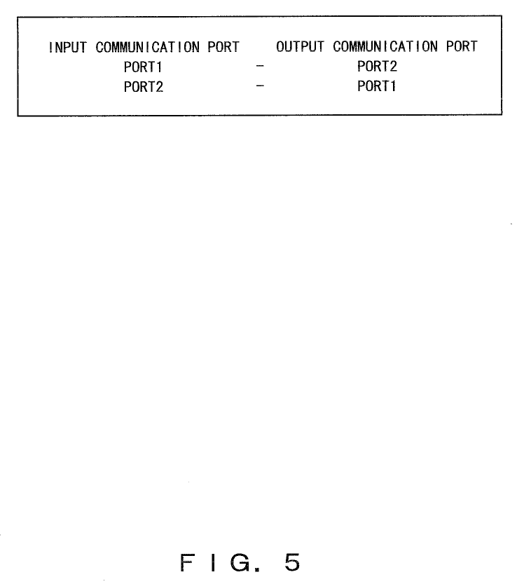

When the mode is shifted to the disaster operation mode, the CPU 113 refers to a disaster database stored in the memory 114 as shown in the example of FIG. 5 and controls the L2/L3 switch 111 so that data is exchanged only between ports shown in the database.

The example of the disaster database in FIG. 5 shows that, among the data (IP packets) transmitted to the router 101, only the data directed to port 2 from port 1 and the data directed to port 1 from port 2 are transferred, and the rest of the data is not transferred. In other words, the contents of the database indicate that only data communication between port 1 and port 2 is permitted.

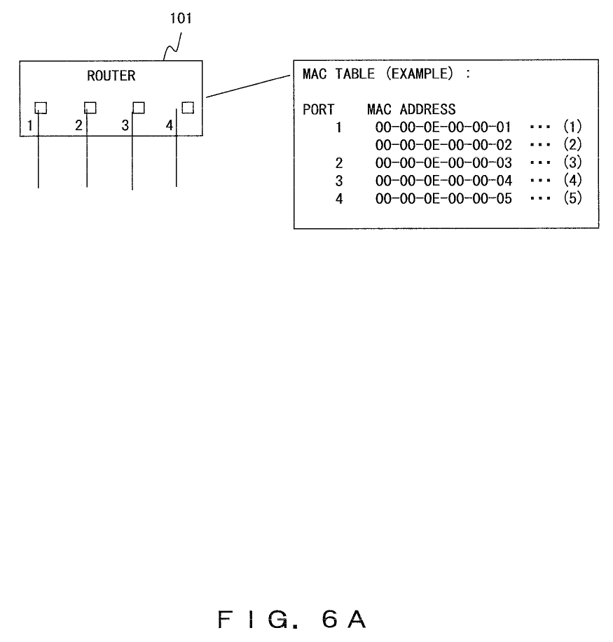

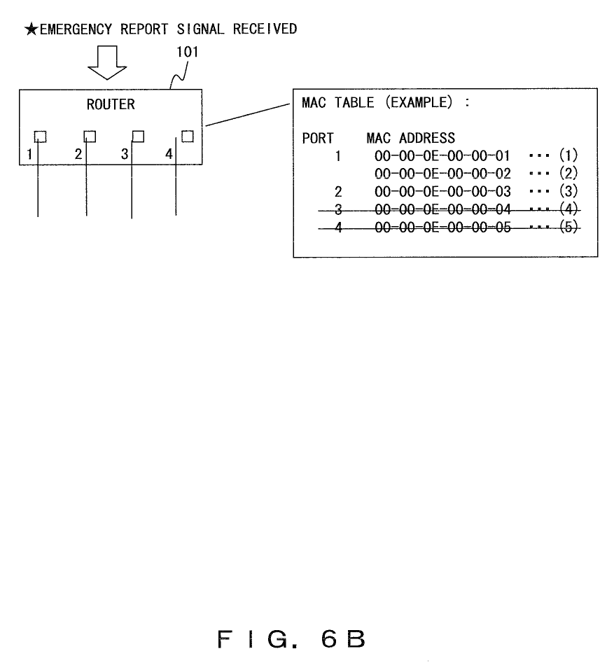

The operation of the router 101 when the disaster database is set as shown in FIG. 5 is set forth with reference to FIG. 6A and FIG. 6B. Note that four ports have been provided in the router 101 in order to simplify the explanation.

FIG. 6A shows an example of a MAC (Media Access Control) table stored in the memory 114 of the router 101 operating in the normal operation mode.

According to the example, if an IP packet directed to a MAC address of (5) shown in FIG. 6A is received by the port 1 of the router 101, for example, the router 101 transfers the IP packet to the port 4 and afterward transmits the packet. As another example, if an IP packet directed to a MAC address of (3) shown in FIG. 6A is received by the port 1, the router 101 transfers the IP packet to the port 2 and afterward transmits the packet.

On the other hand, FIG. 6B shows an example of the MAC table stored in the memory 114 of the router 101 operating in the disaster operation mode in response to the reception of the emergency report signal by the wireless system 102.

When the disaster database is set as shown in FIG. 5, the CPU 113 of the router 101 controls the L2/L3 switch 111 on the basis of the contents of the disaster database shown in FIG. 5, and shuts down ports 3 and 4 of the router 101 so that data can only be exchanged between ports 1 and 2. With the shutting down of ports 3 and 4, items (4) and (5) relating to ports 3 and 4 in the contents of the MAC table are deleted as shown in FIG. 6B. Accordingly, if port 1 of the router 101 receives an IP packet directed to the MAC address of (3) shown in FIG. 6B, for example, the router 101 transfers the IP packet to port 2 and transmits the packet. However, if port 1 receives an IP packet directed to the MAC address of (5) shown in FIG. 6B, for example, the router 101 discards the IP packet.

It should be noted that a common Layer 2 switch, when receiving an IP packet that does not have a destination shown in the MAC table, broadcasts the IP packet to all ports. However, in the present embodiment, the IP packet is to be discarded in the same situation.

As explained above, in the router 101 shown in FIG. 1, when being notified of the reception of the emergency report signal from the wireless system 102, the CPU 113 refers to the database shown in FIG. 5, forcibly shifts, on the basis of the contents of the database, those circuits of PHY 112-1 to 112-5 that correspond to ports 3-6 for the use of general communications to a link-down status (disconnection of the communication link with the counter apparatus) for prohibition of the communication, and performs only data exchange between the port 1 to which the wireless system 102 is connected and the port 2 to which the counter apparatus for the specially-designated communication is connected.

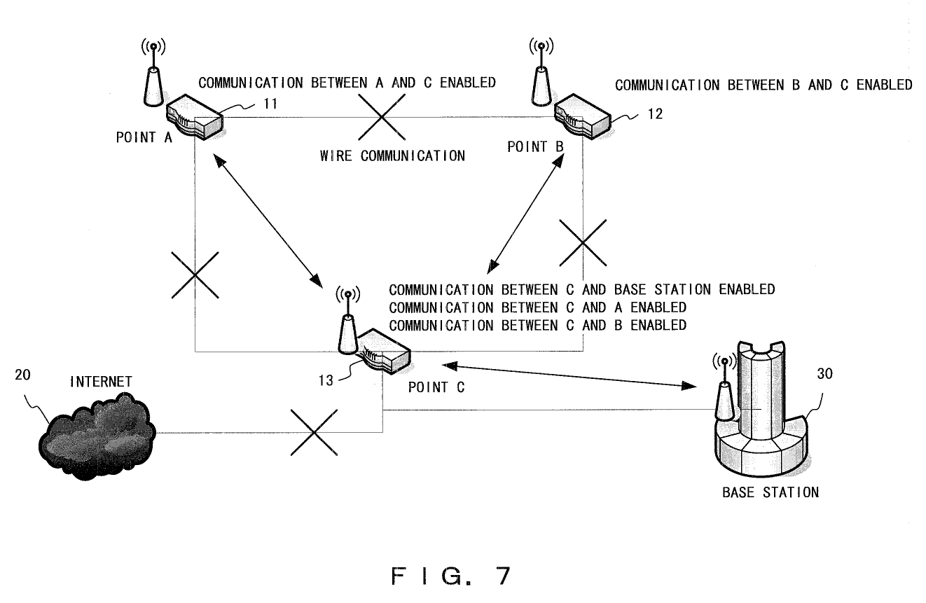

An example of settings of the disaster database and MAC table in the router 101 provided in each of the network apparatuses 11, 12 and 13 is shown in FIG. 7. Note that the settings are set in advance when the communication network shown in FIG. 1 is established.

In FIG. 7, the router 101 in the network apparatus 11 at a point A, for example, has the same setting contents of the disaster database as the example shown in FIG. 5. In the MAC table, the MAC address of the network apparatus 13 at a point C is set to an item of the port 1 and the MAC address of the counter apparatus for the specially-designated communication with point A is set.

In the communication network in which the network apparatuses 11, 12 and 13 have the settings shown in FIG. 7, after the operation mode shifts to the disaster operation mode, communications are conducted according to the setting contents. As a result, the wireless communication channels between point A and point C, between point B and point C and between point C and the base station are ensured under emergency conditions, and the IP packet that performs the specially-designated communication can be directly transferred between these nodes. Between point A and point B, also, if the counter apparatus for a specially-designated communication at point C is used as a repeater apparatus, the IP packet performing the specially-designated communication can be indirectly transferred.

The CPU 113 of the router 101 provided to each of the network apparatuses 11, 12 and 13 conducts processing for reducing the power consumption of the router 101 after the operation mode is shifted to the disaster operation mode and the communication direction for the specially-designated communication is determined. In other words, processing is performed to stop the functions provided by the hardware resources of the router 101 that are not necessary to maintain the communication channel for the specially-designated communication. As a result of the processing, if a situation arises in which a blackout of the commercial power source occurs due to a disaster or any other such reason and operation by the backup power source is performed, the operation time under backup power can be prolonged.

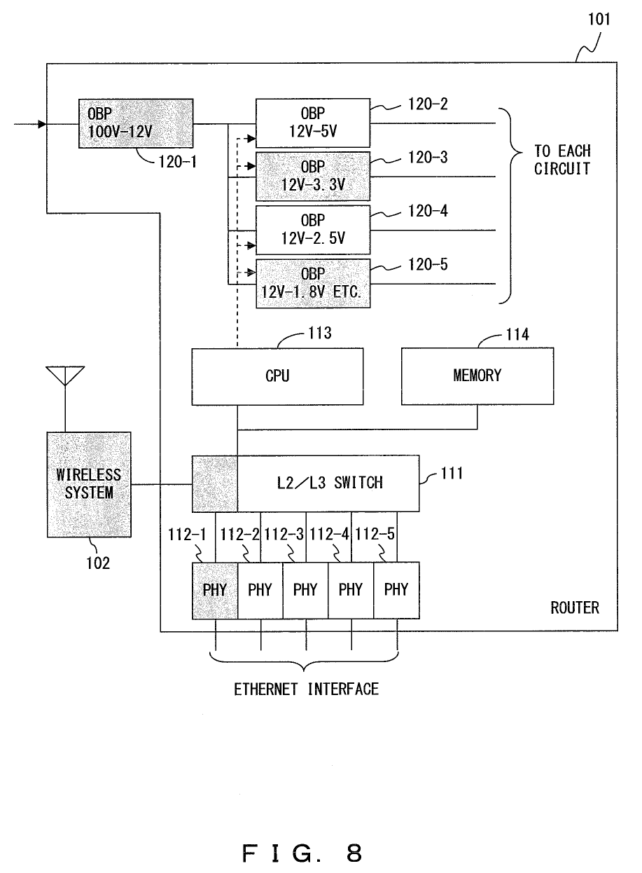

FIG. 8 shows the hardware resources required to maintain the communication channels for specially-designated communication in the configuration of the router 101 shown in detail in FIG. 3. Here, the hardware resources described in the shaded regions in FIG. 8 that are a part of the L2/L3 switch 111, PHY 112-1, and OBPs 120-1, 120-3, 120-5 of the configuration of the router 101 shown in detail are the hardware resources that are required in addition to the wireless system 102 to maintain the communication channels for the specially-designated communication.

Accordingly, the CPU 113 stops the functioning of all of the hardware resources other than the above after determining the communication direction of the specially-designated communication, and furthermore, stops the functioning of the CPU 113 itself.

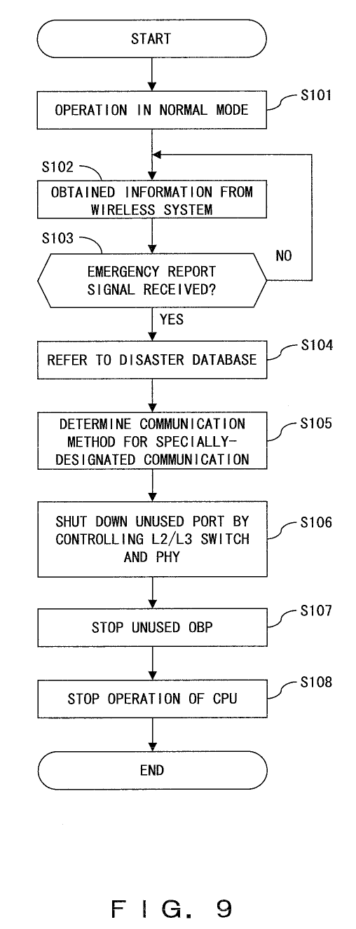

In the following description, FIG. 9 is explained. FIG. 9 is a flowchart showing the processing contents of the control processing for the disaster operation mode performed by the CPU 113. The control processing of FIG. 9 can be realized by the CPU 113 reading out and executing the control program stored in the memory 114.

The processing of FIG. 9 starts when the power is supplied to the router 101, and in S101, first, processing for operation of the router 101 in a normal operation mode is performed.

Next, in S102, processing for obtaining information to be reported from the wireless system 102 is performed. In S103 that follows, processing is performed for determining whether or not the information indicating the notice of the reception of the emergency report signal from the base station 30 is obtained from the wireless system 102. At that time, if it is determined that the notice has been obtained (the determination result is Yes), the processing proceeds to S104. If it is determined that the notice has not been obtained (the determination result is No), the processing is returned to S102 and the above processing is repeated.

In S104, processing for referring to the contents of the disaster database is stored in the memory 114. In S105 that follows, processing for determining the communication direction for the specially-designated communication is performed according to the contents of the disaster database.

In S106, according to the determined communication direction, processing for shutting down the ports not used for the specially-designated communication is performed by controlling the L2/L3 switch 111 and PHY 112-1 to 112-5.

In S107, with the control of OBPs 120-2 to 120-5, processing for blocking the power supply by stopping those OBPs that supplied power only to the hardware resources shut down in S106 is performed. In S108 that follows, processing for stopping the operation of the CPU 113 is performed, and afterward the processing in FIG. 9 is ended. Note that the processing of S108 is to be performed before the CPU 113 becomes unable to operate normally due to a decline in the power voltage supplied to the CPU 113. As described above, by stopping the operation of the OBP itself rather than by merely cutting the power supply line from the OBP to the hardware resources, the power loss that occurred in the OBP can be reduced.

As a result of the CPU 113 of the router 101 performing the above processing, it is possible to shift the operation status of the router 101 from the normal operation mode to the disaster operation mode in response to the reception of an emergency report signal from the base station 30 and to operate the router 101. Note that to restore the normal operation mode of the operation status of the router 101 from the disaster operation mode, the router 101 is manually restarted, for example.

As explained above, in the communication network shown in FIG. 1 comprising the network apparatuses 11, 12 and 13 relating to the present embodiment, because the router 101 constituting the network apparatuses 11, 12 and 13 operates as described above, specially-designated communications can be ensured in a time of emergency. The operation is stopped for OBPs 120-1 to 120-5 that comprise the power source system in the router 101 other than those OBPs supplying the power consumed for IP packet exchange between ports shown in the disaster database, and therefore, in operation under the auxiliary power source during a blackout of the commercial power source, it is possible to maintain communication channels for specially-designated communications for a longer time period than ever before.

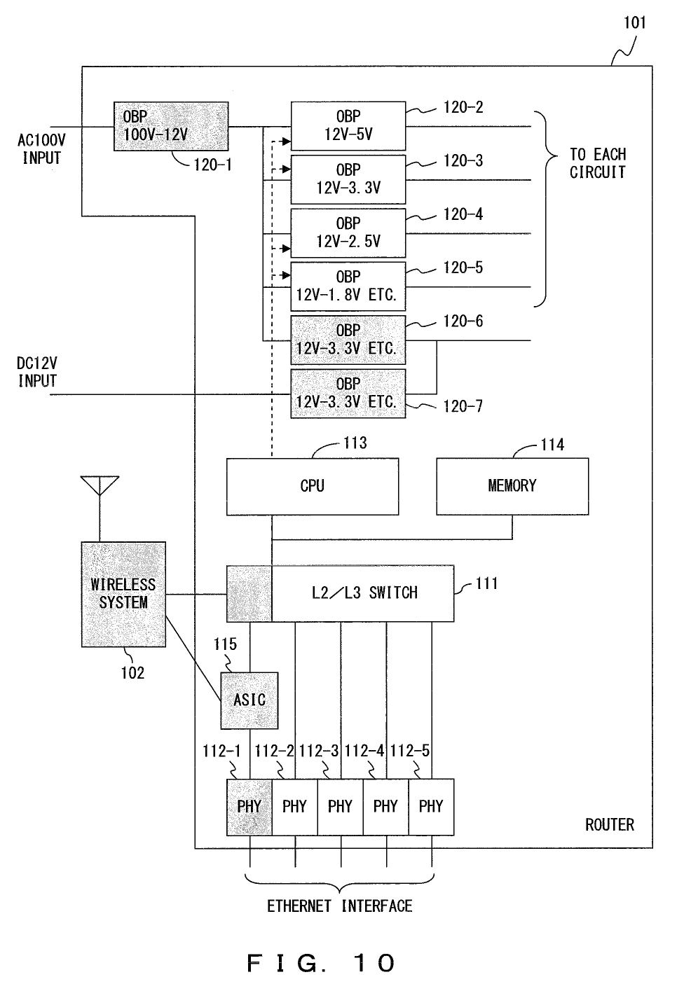

FIG. 10 is explained next. FIG. 10 shows a second detailed example of a configuration of the router 101 shown in FIG. 2. Note that in the following description, points in the configuration shown in FIG. 10 that are different from those of the first example shown in FIG. 3 are explained.

In the second example shown in FIG. 10, an ASIC (Application Specific Integrated Circuit) 115 is provided between the L2/L3 switch 111 and PHY 112-1. The operation of the ASIC 115 is controlled by the CPU 113. The CPU 113 connects the L2/L3 switch 111 and PHY 112-1 by the ASIC 115 and causes the transfer of IP packets between the L2/L3 switch 111 and PHY 112-1 when causing the router 101 to operate in the normal operation mode. Meanwhile, to operate the router 101 in the disaster operation mode, the wireless system 102 and PHY 112-1 are connected by the ASIC 115, and the IP packets are directly transferred between the wireless system 102 and PHY 112-1 without going through the L2/L3 switch 111. As a result, it is possible to completely stop the L2/L3 switch 111 that consumes a prominently large amount of power among the hardware resources constituting the router 101 in the disaster operation mode, and thus the communication channels for the specially-designated communication can be maintained for a longer time period than ever before.

It should be noted that in the example of FIG. 10, PHY 112-1 and the ASIC 115 have configurations that can be driven by power output from OBP 120-6 or 120-7 alone. Accordingly, the CPU 113 performs processing to stop power from being supplied by controlling OBPs 120-2 to 120-5 after ending the processing to shut down the ports not being used in the specially-designated communication by controlling the L2/L3 switch 111 and PHY 112-1 to 112-5.

The example of FIG. 10, additionally, has a configuration in which it is assumed that a power source output of 12 volts of DC voltage (e.g., the 12-volt battery commonly used in passenger cars) is used rather than a UPS that outputs 100 volts of AC voltage as the auxiliary power source, and when this power source is used, OBP 120-7 converts the power source voltage to supply to PHY 112-1 and the ASIC 115. Here, in the disaster operation mode, while a commercial power source of 100 VAC is supplied, OBP 120-6 is operated and the operation of OBP 120-7 is stopped. When the output voltage of OBP 120-6 falls below a prescribed threshold due to a blackout of the commercial power source, OBP 120-7 is operated and OBP 120-6 is stopped, and power is continued to be supplied to PHY 112-1 and the ASIC 115.

It should be noted that the present invention is not limited to the above-described embodiments; however, various improvements and modifications can be made within a scope that does not depart from the essence of the present invention.

What is claimed is:

1. A network apparatus comprising:
a data exchange unit comprising a plurality of ports transferring data, for exchanging data between the ports;
a database for registering information of a port exchanging data;
a detection unit for detecting reception of a specified signal; and
a control unit for controlling the data exchange unit when the detection unit detects the reception of the specified signal, for causing data exchange only between ports indicated by the information registered in the database and stopping data transfer of other ports among the plurality of ports.

2. The network apparatus according to claim 1, wherein
the data is an IP packet.

3. The network apparatus according to claim 1, wherein
the data exchange unit is an L2/L3 switch.

4. The network apparatus according to claim 1, wherein
the detection unit detects reception of the specified signal transmitted via a wireless communication channel.

5. The network apparatus according to claim 1, wherein
the specified signal detected by the detection unit is a signal with a specified frequency.

6. The network apparatus according to claim 1, wherein
the control unit, when the detection unit detects reception of the specified signal, blocks a supply of power consumed for data transfer in a port other than the port indicated in the information registered in the database.

7. The network apparatus according to claim 6, wherein
the control unit, when the detection unit detects reception of the specified signal, stops the operation of all of a plurality of power source systems comprised in the network apparatus except for the operation of a power source system supplying power consumed for data exchange between ports indicated in the information registered in the database.

8. The network apparatus according to claim 6, wherein
the control unit stops the operation of a power source system supplying power consumed for the control unit executing control operation after the control of the data exchange is conducted in response to the reception of the specified signal by the detection unit.

9. A control method of a network apparatus comprising a plurality of ports transferring data and data exchange equipment for data exchange between the ports, comprising:
establishing of a database in a storage unit comprised in the network apparatus by registering information of a port exchanging data;
determining whether or not a detection unit for detecting reception of a specified signal comprised in the network apparatus detected the reception of the specified signal; and
causing the data exchange equipment, when detecting that the detection unit detects the reception of the specified signal, to exchange data only between ports indicated by information registered in the database and to stop data transfer of the other ports among the ports.

10. A control apparatus of a network apparatus comprising a plurality of ports transferring data and data exchange equipment for data exchange, comprising:
a database having information of a port exchanging data registered;
a detection unit for detecting reception of a specified signal; and
a control unit for causing data to be exchanged only between ports indicated by the information registered in the database and to stop data transfer of the other ports among the plurality of ports by controlling data exchange equipment comprised in the network apparatus when the detection unit detects reception of the specified signal.
